(19) United States
(12) Patent Application Publication
(10) Pub. No.: US 2025/0086877 A1
(43) Pub. Date: Mar. 13, 2025

(54) CONTENT-ADAPTIVE 3D RECONSTRUCTION

(71) Applicant: QUALCOMM Incorporated, San Diego, CA (US)

(72) Inventors: Adithya Reddy NALLABOLU, San Diego, CA (US); Gokce DANE, San Diego, CA (US); Vasudev BHASKARAN, San Diego, CA (US)

(21) Appl. No.: 18/465,930

(22) Filed: Sep. 12, 2023

(51) Int. Cl. G06T 15/08

(52) U.S. Cl. CPC G06T 15/08

(57) ABSTRACT

This disclosure provides systems, devices, apparatus, and methods, including computer programs encoded on storage media, for content adaptive 3D reconstruction. A graphics processor may compute a curvature of content in a block volume that represents a 3D scene, where the block volume includes a set of voxels. The graphics processor may select a number of the set of voxels in the block volume based on the computed curvature of the content. The graphics processor may output an indication of the selected number of the set of voxels in the block volume.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques for three-dimensional (3D) reconstruction may be computationally complex, bandwidth complex, memory complex, and/or may be associated with relatively high latencies. There is a need for improved 3D reconstruction techniques.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for graphics processing are provided. The apparatus includes a memory; and a processor coupled to the memory and, based on information stored in the memory, the processor is configured to: compute a curvature of content in a block volume that represents a three-dimensional (3D) scene, where the block volume includes a set of voxels; select a number of the set of voxels in the block volume based on the computed curvature of the content; and output an indication of the selected number of the set of voxels in the block volume.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a graphics processing unit (GPU)) in accordance with one or more techniques of this disclosure.

FIG. 3 illustrates an example image or surface in accordance with one or more techniques of this disclosure.

FIG. 4 is a diagram illustrating an example of dynamic block volume size adjustment in accordance with one or more techniques of this disclosure.

FIG. 5 is a diagram illustrating an example of block volumes and voxels in accordance with one or more techniques of this disclosure.

FIG. 6 is a diagram illustrating an example of surface normal histogram and variance calculations in accordance with one or more techniques of this disclosure.

FIG. 7 is a diagram illustrating an example of content adaptive three-dimensional reconstruction (3DR) in accordance with one or more techniques of this disclosure.

FIG. 8 is a diagram illustrating an example of managing voxel sample data with different block sizes in accordance with one or more techniques of this disclosure.

FIG. 9 is a call flow diagram illustrating example communications between a graphics processor and a graphics processor component in accordance with one or more techniques of this disclosure.

FIG. 10 is a flowchart of an example method of graphics processing in accordance with one or more techniques of this disclosure.

FIG. 11 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory).

Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

Three-dimensional (3D) reconstruction may refer to a process of capturing shape(s) and appearance(s) of objects based on input frame(s). 3D reconstruction may generate mesh(es) of object(s) in a 3D scene. In 3D reconstruction, 3D scenes may be represented using a 3D volume of points, which may be referred to as voxels. Each voxel may carry implicit surface information in the form of a truncated signed distance function (TSDF) value and a weight for depth integration. Some 3D reconstruction algorithms may sample voxels in a 3D space uniformly along an x-axis, a y-axis, and a z-axis (i.e., an equal number of voxels are sampled along the x-axis, the y-axis, and the z-axis). The 3D space may be divided into fixed size volumes (i.e., block volumes). The block volumes may be processed as depth values are integrated using a six degrees-of-freedom (6DOF) camera pose.

In order to produce a relatively high quality mesh, a 3D reconstruction algorithm may sample a 3D space using a relatively small sample distance; however, relatively small sample distances may increase computational complexity, bandwidth complexity, and/or memory complexity by a cubic order (e.g., ON³)). Some 3D reconstruction algorithms may not take into account types of content (e.g., planar surfaces, spherical surfaces, etc.) that are present in a block volume. Furthermore, some 3D reconstruction algorithms may utilize static hyper parameters (e.g., ramp size) across a 3D scene, which may negatively affect a quality of an output mesh.

Various technologies pertaining to content-adaptive 3D reconstruction are described herein. In an example, an apparatus (e.g., a graphics processor) computes a curvature of content in a block volume that represents a three-dimensional (3D) scene, where the block volume includes a set of voxels. The apparatus selects a number of the set of voxels in the block volume based on the computed curvature of the content. The apparatus outputs an indication of the selected number of the set of voxels in the block volume. Vis-à-vis selecting the number of the set of voxels based on the computed curvature of the content in the block volume, the apparatus may reduce a compute complexity, a bandwidth complexity, and a memory complexity for a complete 3D reconstruction while still producing high fidelity output meshes

In one aspect described herein, 3D space may be dynamically sampled based on content present in a block volume. For example, block volumes containing walls or floors may be sampled with a larger sample distance, while block volumes containing intricate (high curvature) objects may be sampled with a lower sample distance (associated with higher quality meshes). The content may be analyzed by calculating a surface normal histogram and a surface normal variance. For example, intricate objects may have a high surface normal variance. In another aspect described herein, memory may be dynamically allocated based on a type of content present in block volumes.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

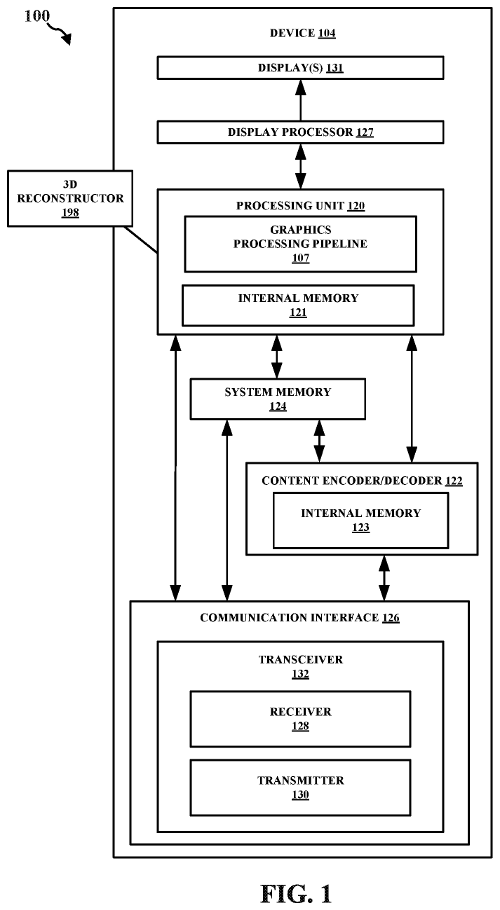

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123.

In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, a GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a 3D reconstructor 198 configured to compute a curvature of content in a block volume that represents a three-dimensional (3D) scene, where the block volume includes a set of voxels; select a number of the set of voxels in the block volume based on the computed curvature of the content; and output an indication of the selected number of the set of voxels in the block volume. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

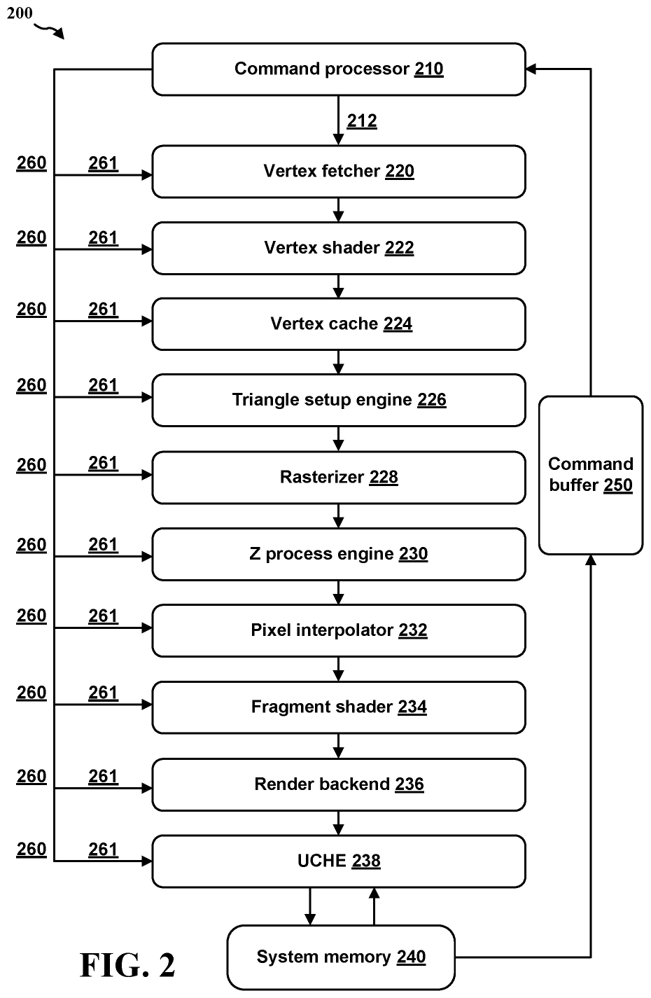

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin. Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

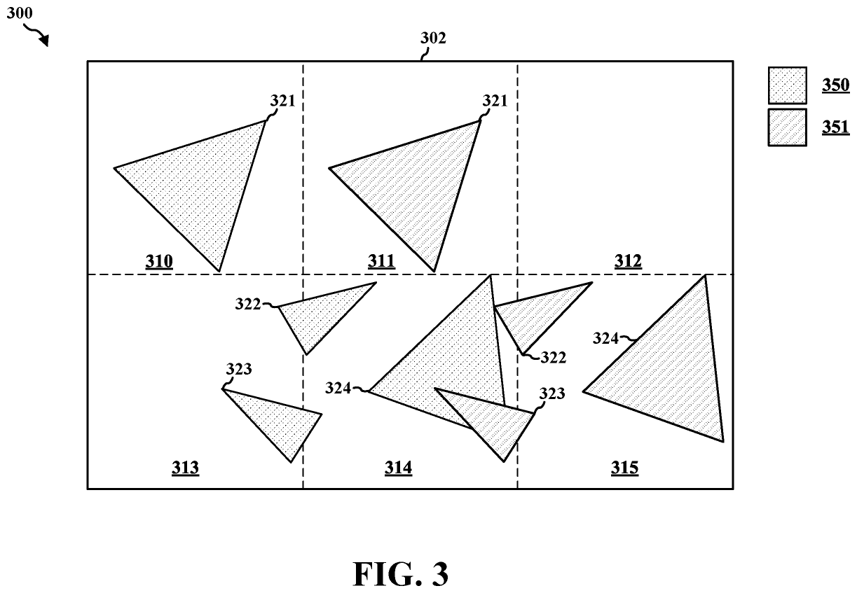

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

Three-dimensional (3D) reconstruction may refer to a process of capturing shapes and appearance of objects based on input frame(s). 3D reconstructions may generate a mesh of objects in a 3D scene. In 3D reconstruction, 3D scenes may be represented using a 3D volume of points, which may be referred to as voxels. Each voxel may carry implicit surface information in the form of a truncated signed distance function (TSDF) value and a weight for depth integration. A TSDF value may be a measure from a distance of a voxel from a surface (e.g., a surface of an object). A TSDF value may be a positive value if the voxel is outside of the object or the TSDF value may be a negative value if the voxel is inside the object. A weight for depth integration may be a measure of a reliability of a TSDF value. A 3D reconstruction algorithm/system may take a sequence of depth maps with corresponding 6DOF poses as an input and the 3D reconstruction algorithm/system may output a mesh based on the input.

Some 3D reconstruction algorithms may sample voxels in a 3D space uniformly along an x-axis, a y-axis, and a z-axis. The 3D space may be divided into fixed size volumes with a fixed number of samples along the x-axis, the y-axis, and the z-axis (i.e., x, y, and z directions). The fixed sized volumes may be referred to as block volumes. The block volumes may be processed as depth values are integrated using a 6DOF camera pose.

In order to produce a high quality mesh (i.e., a mesh that accurately represents an object), a 3D reconstruction algorithm may sample the 3D space with a relatively small sample distance; however, small sample distances may increase a compute complexity, a bandwidth complexity, and/or a memory complexity by a cubic order (i.e., ON³)). While larger sample distances may reduce the compute complexity, the bandwidth complexity, and the memory complexity, larger sample distances may produce lower quality meshes. Some 3D reconstruction algorithms may not be configured to determine a type of 3D content (e.g., a plane, a sphere, a cylinder, etc.) that is present in a block volume. Some 3D reconstruction algorithms may use static hyper parameters (e.g., a ramp size that determines an integration distance) across a 3D scene. As a result of the static hyper parameters, some 3D reconstruction algorithms may not yield high quality output meshes for different types of 3D surface textures. Furthermore, some 3D reconstruction algorithms may not dynamically sample a 3D space based on content present inside a block volume.

Various technologies pertaining to content-adaptive 3D reconstruction are described herein. For instance, a framework is described herein for dynamically sampling 3D space based on content present in block volumes. For example, block volumes containing walls or floors may be sampled with a larger sample distance while block volumes containing intricate (i.e., high curvature) objects may be sampled with a lower sample distance. With more particularity, an example indoor 3D scene may include walls, floors, furniture, and plants and other intricate objects. In accordance with the various technologies described herein, 3D spaces of walls, floors, and other planar objects may be sampled with a relatively large sample distance (as opposed to a relatively small sample distance), while 3D spaces of plants and other intricate objects may be sampled densely with a relatively small sample distance in order to produce a relatively high quality 3D mesh (i.e., a 3D mesh with high fidelity). This may reduce a computational complexity, a bandwidth complexity, and a memory complexity for 3D reconstruction associated with simple objects (e.g., walls, floors, planar objects, etc.) while also producing high quality meshes for more complex objects (e.g., plants).

In one aspect, an efficient procedure for understanding content in a block volume is described herein. The procedure may involve calculating a surface normal histogram and a surface normal variance. The surface normal histogram may represent 3D content using an aggregate of local surface normals computed across a block volume. For example, a wall or a floor in a block volume may have a single surface normal, while a plant may have a high surface normal variance (i.e., local surface normals pointing in different directions). Aspects presented herein may also improve a 3D mesh quality by dynamically tuning hyper parameters based on 3D content.

Furthermore, an end-to-end framework for software and hardware is described herein that may be used to implement a (dynamic) 3D reconstruction algorithm. The 3D reconstruction algorithm may dynamically allocate memory and computational resources based on content present in block volumes.

The technologies described herein may be associated with various advantages. For instance, the 3D reconstruction algorithm described herein (i.e., a content-adaptive 3D reconstruction algorithm) may be efficient to implement in hardware. The 3D reconstruction algorithm described herein may reduce a compute complexity, a bandwidth complexity, and a memory complexity for a complete 3D reconstruction while still producing high fidelity output meshes. The 3D reconstruction algorithm described herein may introduce intelligence into 3D reconstruction in order to understand content and auto-tune (i.e., adapt) 3D reconstruction hyper parameters (e.g., ramp, etc.) such that the adapted 3D reconstruction hyper parameters are more suitable for different surface textures. Surface normal histograms and variance computed as part of the 3D reconstruction algorithm described herein may be used to determine if a plane is to be fitted to a block volume (i.e., block volume data). Additionally, given a constraint on computational resources and/or memory resources, the 3D reconstruction algorithm described herein may determine and allocate the computational resources and/or the memory resources based on 3D content.

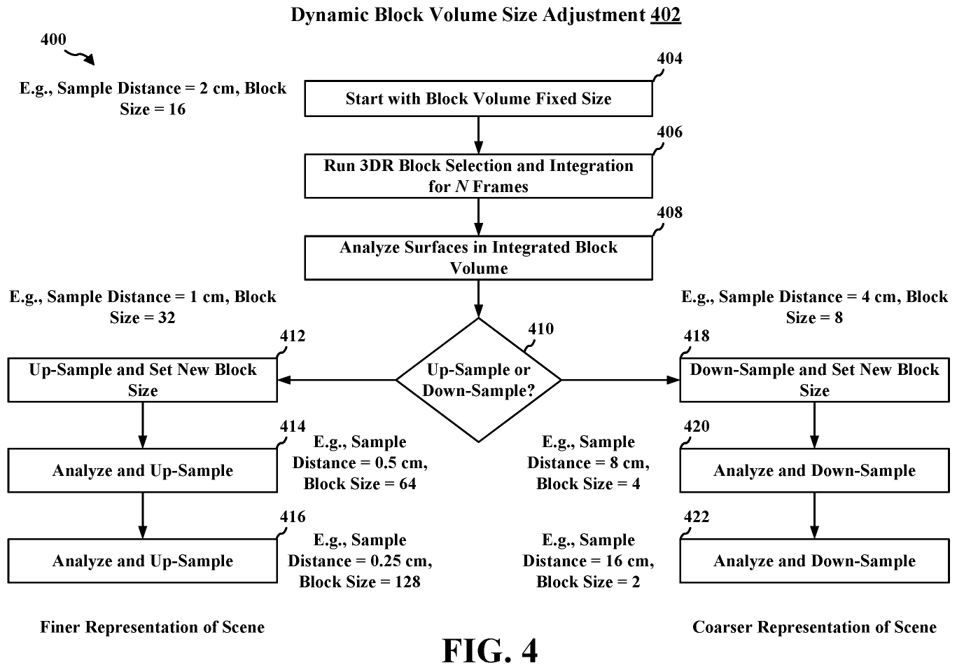

FIG. 4 is a diagram 400 illustrating an example of dynamic block volume size adjustment 402 in accordance with one or more techniques of this disclosure. At 404, a device (e.g., the device 104, a graphics processor of the device 104, the processing unit 120 of the device 104, the GPU 200, etc.) may start with a fixed block volume size, that is, the device may determine/select/receive an indication of a block volume, where the indication of the block volume may include an initial block size and an initial sample distance. The fixed block volume size may be specified by a configuration. A block volume may refer to a division of a 3D space, where the 3D space includes voxels (e.g., a set of voxels). A voxel may refer to a point in 3D space. A voxel may include/be associated with a truncated signed distance function (TSDF) value and a weight for depth integration. The TSDF value may be a measure of a distance of the voxel from a surface. The weight may be a measure of a reliability of the TSDF value. A block size may refer to a number of voxels included along an axis of the block volume. A sample distance may refer to a distance at which voxels are sampled in the block volume. In an example, the initial block size may be 16 and the initial sample distance may be 2 centimeters (cm).

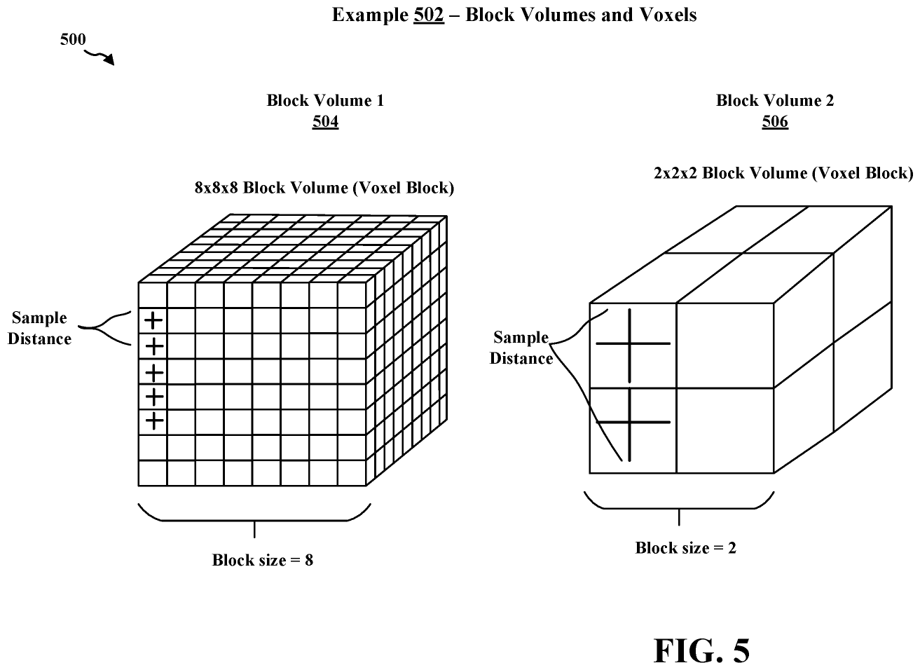

FIG. 5 is a diagram 500 illustrating an example 502 of block volumes and voxels in accordance with one or more techniques of this disclosure. The diagram 500 depicts a first block volume 504 and a second block volume 506. The first block volume 504 (which may also be referred to as a first voxel block) may have a block size of 8. When the first block volume 504 is sampled with a sample distance of 0.5 cm, a 4 cm×4 cm×4 cm sampled block volume may be obtained. The second block volume 506, (which may also be referred to as a second voxel block) may have a block size of 2. When the second block volume 506 is sampled with a sample distance of 2 cm, a 4 cm×4 cm×4 cm sampled block volume may be obtained.

Referring back to FIG. 4, at 406, the device may run a 3D reconstruction (3DR) block selection algorithm and the device may integrate block volumes for N frames, where N is a positive integer. The N frames may include views of a scene from multiple viewpoints. Integrating a block volume may include a sparse block selection and activation stage and a dense voxel value integration stage.

In the sparse block selection and activation stage, a device may un-project depth pixels to points in a camera coordinate frame. The device may transform the points into a global coordinate system using a camera 6DOF pose. The device may select blocks which contain the points as blocks to be integrated with a current frame.

In the dense voxel value integration stage, the device may project 3D voxels onto a depth frame using the camera 6DOF pose. The device may use a depth value at a pixel location to calculate a TSDF value at a 3D voxel. The device may compute a weighted average of a current TSDF value with a previous value at the 3D voxel location. Integrating the block volume may result in smooth surfaces (e.g., by removing noise via weighted averaging of the TSDF values). The smooth surfaces may be utilized to estimate a curvature of a 3D surface in a block volume.

At 408, the device may analyze surfaces in the integrated block volume in order to determine a type of content (e.g., a plane, a sphere, etc.) present in the integrated block volume. Aspects pertaining to 408 will be discussed in greater detail below. At 410. the device may determine whether up-sampling or down-sampling is to be performed based on the type of content present in the integrated block volume.

In one example, at 412, the device may up-sample the integrated block volume and the device may set a new block volume size based on the up-sampling. For instance, the device may reduce the sample distance from 2 cm to 1 cm, which may increase the block size from 16 to 32. At 414, the device may analyze the new block volume (e.g., the block volume with the block size of 32) in a manner similar to that described above in 408 and the device may perform additional up-sampling. For instance, the device may reduce the sample distance from 1 cm to 0.5 cm, which may increase the block size from 32 to 64. At 416, the device may analyze the new block volume (e.g., the block volume with the block size of 64) in a manner similar to that described above in 408 and the device may perform additional up-sampling. For instance, the device may reduce the sample distance from 0.5 cm to 0.25 cm, which may increase the block size from 64 to 128. The device may cease performing the up-sampling after 416 based on certain criteria being met (e.g., based on a resultant mesh meeting certain quality characteristics). The up-sampling performed at 412, 414, and 416 may lead to a finer representation of a scene (i.e., a 3D scene). Alternatively, the device may cease performing up-sampling after 412 or 414 based on the certain criteria being met. In another example, at 418, the device may down-sample the integrated block volume and the device may set a new block volume size based on the down-sampling. For instance, the device may increase the sample distance from 2 cm to 4 cm, which may reduce the block size from 16 to 8. At 420, the device may analyze the new block volume (e.g., the block volume with the block size of 8) in a manner similar to that described above in 408 and the device may perform additional down-sampling. For instance, the device may increase the sample distance from 4 cm to 8 cm, which may decrease the block size from 8 to 4. At 422, the device may analyze the new block volume (e.g., the block volume with the block size of 4) in a manner similar to that described above in 408 and the device may perform additional down-sampling. For instance, the device may increase the sample distance from 8 cm to 16 cm, which may reduce the block size from 4 to 2. The device may cease performing the down-sampling after 422 based on certain criteria being met (e.g., based on a resultant mesh meeting certain quality characteristics). The down-sampling performed at 418, 420, and 422 may lead to a coarser representation of a scene (i.e., a 3D scene). Alternatively, the device may cease performing down-sampling after 418 or 422 based on the certain criteria being met.

In the adaptive up-sampling and down-sampling illustrated in FIG. 4, each block volume size in terms of metric units (e.g., cm) may remain the same; however, a number of voxels in each block volume may be adapted.

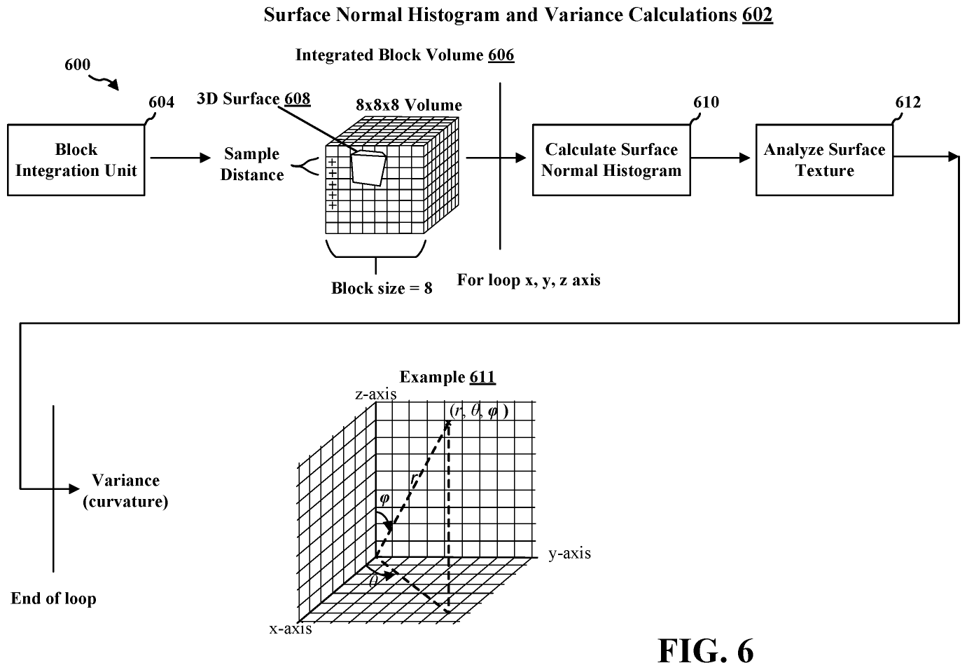

FIG. 6 is a diagram 600 illustrating an example of surface normal histogram and variance calculations 602 in accordance with one or more techniques of this disclosure. A device (e.g., the device 104, a graphics processor of the device 104, the processing unit 120 of the device 104, the GPU 200, etc.) may run a block integration unit 604 in order to obtain an integrated block volume 606, where the integrated block volume 606 may include a 3D surface 608. The block integration unit 604 may correspond to 406 in FIG. 4.

At 610, the device may calculate a surface normal histogram for a 3D surface 608 in the integrated block volume 606. Calculating the surface normal histogram may correspond to 408 in FIG. 4. A surface normal histogram may quantize surface normals into respective spherical coordinate angles (e.g., θ and φ which are associated with a distance r), insert the spherical angle coordinates into bins, and show a surface normal frequencies for a surface. FIG. 6 includes an example 611 of spherical coordinate angles. A surface normal may refer to a vector which is perpendicular to a surface at a given point (i.e., at a given voxel). In an example, the device may calculate surface normal histograms according to the following pseudocode listed below.

SurfaceNormalHistogram=[0, 0, . . . 0], . . . [0, 0, . . . . 0]] #initialize 2D matrix with zeros

For x in range (0, block_size-k):
For y in range (0, block_size-k):
   For z in range (0, block_size-k):
      localVolume=block Volume (x: x+k, y: y+k, z: z+k)
      if (localVolume contains a surface ramp)
   [a, b, c]=surfaceNormal (localVolume) #normalized gradients along x, y, Z
      phi=arccos (c)
      theta=arctan (a/b)
      SurfaceNormalHistogram [quantize (phi), quantize (theta)]+=1

The following pseudocode . . .
localMaximas=determineLocalMaxima (SurfaceNormalHistogram) #finds local maxima's

If (sizeof (localMaximas)>K): #surface normal's in more than K dominant directions

Mean, var=fit2DGaussian (SurfaceNormalHistogram)
return var # over all curvature

else:
max_var=0 #max curvature
for local in localMaximas:

Mean, var=fit2DGaussian (SurfaceNormalHistogram, local) # for each surface calculate curvature
max_var=max (var, max_var) return max_var

At 612, the device may analyze a surface texture of the 3D surface 608 based on the surface normal histogram calculated at 610. Analyzing the surface texture at 612 may also correspond to 408 in FIG. 4. Analyzing the surface texture of the 3D surface 608 may include calculating a surface variance (i.e., a curvature) and/or calculating local maxima associated with the 3D surface 608. The surface variance and/or a number of the local maxima may be indicative of different types of surfaces (e.g., a plane, a cylinder, a sphere, etc.). With more particularity, a variance of a local maxima may indicate a type of surface (e.g., a plane, a cylinder, a sphere, etc.) and a number of local maxima may indicate a number of planes associated with a block (i.e., a block volume). The device may classify the 3D surface 608 as a type of surface based on the surface variance and/or the number of local maxima. Table 1 below details various aspects of surface normal histograms for different types of surfaces.

TABLE 1
Surface Normal Histogram Classification
for Various Generic 3 D Shapes

| Example | | 2 D Surface | | Number |
|---|---|---|---|---|
| Object | Surface | Normal | Variance | of Local |
| Type | Type | Histogram | (Curvature) | Maxima |
| Wall | Plane | Dirac Delta | Very Low | 1 |
| | | Function | | |
| | | (Gaussian | | |
| | | with Low | | |
| | | Variance) | | |
| Table | 2 or more | 2 or more | Low | 2 or more |
| | Planes | Dirac Delta | | |
| | | Functions | | |
| Water Jug | Cylinder | Dirac Delta | High | 1 (along 1 |
| | | over 1 Axis | | axis) |
| | | and Uniform | | |
| | | over Another | | |
| | | Axis | | |
| Orange | Sphere | Uniform | Higher | Unknown |
| (fruits) | | Distribution | | |
| | | over 2 axis | | |
| Plants | Arbitrary | Indefinite | Highest | Unknown |
| | Complex | | | |
| | Shape | | | |

As described above and as illustrated in Table 1 above, a surface normal histogram may be used to classify a surface type (e.g., a plane, more than one plane, a cylinder, a sphere, a complex surface, etc.) present in a block volume. A mapping between a surface normal histogram and a surface type may be performed via a look up table (LUT) implementation. The LUT implementation may be or include Table 1 above. In one aspect, a LUT may computed/determined based on a training data set that includes data and TSDF values from different depth inputs. Based on a depth input source, the LUT may be loaded by a device (e.g., the device 104) before or at runtime.

In an example, at 612, the device may analyze the surface texture of the 3D surface 608 and the device may determine that the 3D surface 608 is a flat surface (e.g., a plane) based on the analysis. For instance, the analysis may indicate that the 3D surface 608 has a low variance and one local maxima. As the surface is a flat surface, the device may down-sample (e.g., corresponding to 418 in FIG. 4) the integrated block volume 606 while still obtaining a relatively high quality mesh, that is, the device may increase a sample distance for the integrated block volume 606, which may result in a reduced block size for the integrated block volume 606. In another example, at 612, the device may analyze the surface texture of the 3D surface 608 and the device may determine that the 3D surface 608 is a complex shape (e.g., a plant) based on the analysis. For instance, the analysis may indicate that the 3D surface 608 has a high variance and many local maxima (or an unknown number of local maxima). As the 3D surface 608 is complex, the device may up-sample (e.g., corresponding to 412 in FIG. 4) the integrated block volume 606, that is, the device may decrease a sample distance for the integrated block volume 606, which may result in a larger block size for the integrated block volume 606.

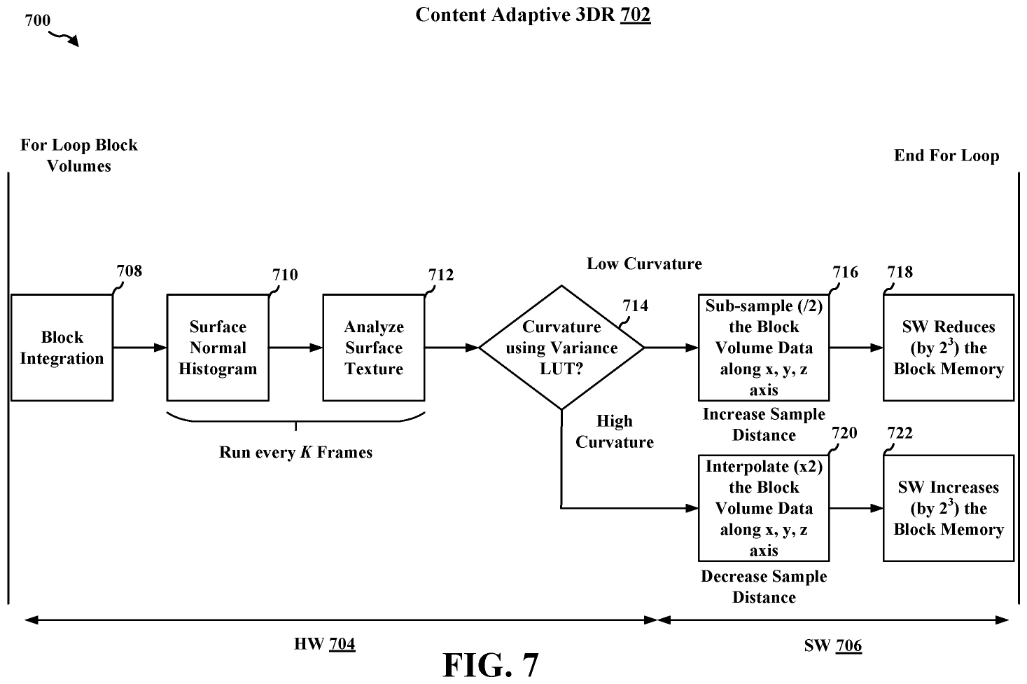

FIG. 7 is a diagram 700 illustrating an example of content adaptive three-dimensional reconstruction (3DR) 702 in accordance with one or more techniques of this disclosure. The 3DR 702 may be performed by hardware (HW) 704 of a device (e.g., the device 104) and/or software (SW) 706 of the device. In an example, the HW 704 may be or include a graphics processor, such as a GPU (e.g., the GPU 200). The 3DR 702 may be implemented via a for loop that is run for multiple block volumes associated with a 3D scene.

At 708, the HW 704 may perform a block integration on a block volume. The HW 704 may also allocate memory for the integrated block volume. In an example, 708 may correspond to 406 in FIG. 4 and/or the block integration unit 604 in FIG. 6. At 710, the HW 704 may compute a surface normal histogram for the integrated block volume. In an example, 710 may correspond to 408 in FIGS. 4 and/or 610 in FIG. 6. At 712, the HW 704 may analyze surface textures of the integrated block volume. In an example, 712 may correspond to 408 in FIGS. 4 and/or 612 in FIG. 6. In an example, 710 and 712 may be performed (i.e., run) every K frames, where K is a positive integer.

At 714, the HW 704 may determine/compute/identify a curvature of a 3D surface in the integrated block volume using a variance LUT. In an example, the variance LUT may be or include Table 1 above. In an example, 714 may correspond to 410 in FIG. 4. The HW 704 may transmit an indication to the SW 706 that indicates whether the 3D surface has a high curvature (i.e., a high variance) or a low curvature (i.e., a low variance). The SW 706 may receive the indication from the HW 704.

At 716, when the received indication indicates that the 3D surface has a low curvature, the SW 706 may sub-sample (i.e., down-sample by increasing a sample distance) block volume data (i.e., sub-sample the integrated block volume) uniformly along an x-axis, a y-axis, and a z-axis. In an example, the SW 706 may divide an initial block size associated with the integrated block volume by 2 to obtain a new block size. In the example, 716 may correspond to 418 in FIG. 4. In the example, at 718, the SW 706 may reduce an amount of memory allocated for the integrated block volume by a certain factor (e.g., a factor of 23). In the example, 718 may also correspond to 418 in FIG. 4.

At 720, when the received indication indicates that the 3D surface has a high curvature, the SW 706 may interpolate (i.e., up-sample by decreasing a sample distance) block volume data (i.e., interpolate the integrated block volume) uniformly along the x-axis, the y-axis, and the z-axis. In an example, the SW 706 may multiply an initial block size associated with the integrated block volume by 2 to obtain a new block size. In the example, 720 may correspond to 412 in FIG. 4. In the example, at 722, the SW 706 may increase an amount of memory allocated for the integrated block volume by a certain factor (e.g., a factor of 23). In the example, 722 may also correspond to 412 in FIG. 4.

Although the 3DR 702 has been described above as being implemented partly by the HW 704 and partly by the SW 706, other possibilities may be complemented. In one example, the HW 704 may perform some or all of the functions (e.g., 716, 718, 720, and/or 722) of the 3DR 702 described above as being performed by the SW 706. In another example, the SW 706 may perform some or all of the functions (e.g., 708, 710, 712, and/or 714) of the 3DR 702 described above as being performed by the HW 704.

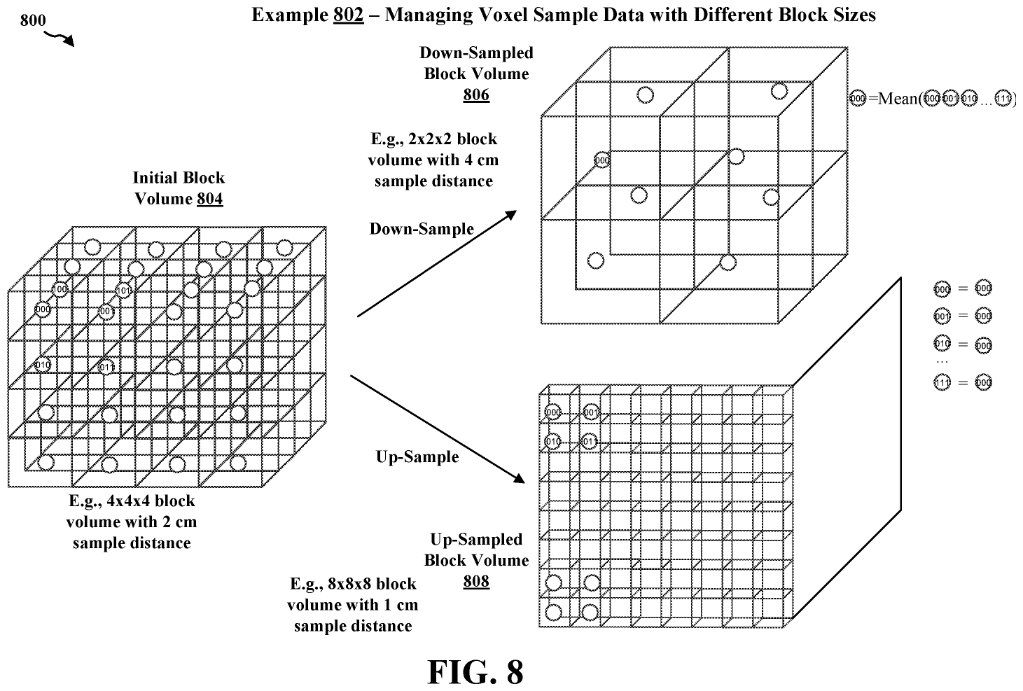

FIG. 8 is a diagram 800 illustrating an example 802 of managing voxel sample data with different block sizes in accordance with one or more techniques of this disclosure. As described above with respect to 404 and 406 in FIG. 4, a device (e.g., the device 104, a graphics processor of the device 104, the processing unit 120 of the device 104, the GPU 200, etc.) may obtain an initial block volume 804. The initial block volume 804 may be an integrated block volume. In an example, the initial block volume 804 may be a 4×4×4 block volume with a 2 cm sample distance. As illustrated in FIG. 8, “000,” “001,” “010,” “011,” “100,” and “101” may correspond to indices of voxels in the initial block volume 804. As described above with respect to 412 and 418 in FIG. 4, new block configurations may be initialized from voxel samples derived from the initial block volume 804 (i.e., from an initial block configuration).

In one example, the device may down-sample the initial block volume 804 to generate a down-sampled block volume 806. In an example, the down-sampled block volume 806 may correspond to 418 in FIG. 4. For example, the device may increase the sample distance from 2 cm to 4 cm to generate a 2×2×2 block volume. The device may compute representative value(s) (e.g., representative TSDF values, representative weights, etc.) for each voxel in order to down-sample the initial block volume 804. For instance, to obtain value(s) for a voxel with an address of “000” in the down-sampled block volume 806, the device may compute a mean of value(s) for voxels with addresses of “000,” “001,” “010,” “011,” “100,” “101,” “110,” and “111” in the initial block volume 804. Alternatively, the device may compute a representative value other than a mean, such as a median value, a nearest value, or an interpolated value.

In one example, the device may up-sample the initial block volume 804 to generate an up-sampled block volume 808. In an example, the up-sampled block volume 808 may correspond to 412 in FIG. 4. For example, the device may decrease the sample distance from 2 cm to 1 cm to generate an 8×8×8 block volume. The device may directly assign TSDF values for voxels in the up-sampled block volume 808 from the initial block volume 804. For instance, for a voxel with an address of “000” in the initial block volume 804, the device may assign addresses of “000,” “001,” “010,” “011,” “100,” “101,” “110,” and “111” in the up-sampled block volume 808.

The block volume sampling described herein may have various advantages of oct tree block volume sampling. An oct tree (which may also be referred to as an octree) may be a tree data structure in which each internal node has eight child nodes. Oct tree block volume sampling may be associated with sampling a block volume associated with an oct tree. Table 2 below details differences between the block volume sampling described herein and oct tree block volume sampling.

TABLE 2
Improved Block Volume Structure vs.
Oct Tree Block Volume Structure

| Improved Block Volume Sampling | Oct Tree Block Volume Sampling |
|---|---|
| Block Volume Size is Changeable | Block Volume Size is Fixed |
| Vary the Sampling Rate of the Block | Vary the Sampling Rate of the Block |
| Volume by Changing the Memory | Volume by Allocating More Block |
| Size (by Increasing the Block Size) | Volumes for the Same 3 D Space |
| Block Volume has a Fixed Sampling | Sampling Rate may vary within a |
| Rate (per Block) | Block Volume |
| Supports Both Up-Sampling and | Supports Up-Sampling |
| Down-Sampling | |
| Low Complexity | High Complexity |

As detailed in Table 2 above, in an oct tree representation, a down-sampling decision may be based on a number of 3D points contained in each block volume. In contrast, in the improved block volume sampling described herein, a down-sampling decision may be based on a content characteristic analysis. Furthermore, the adaptive 3D reconstruction algorithm described herein may also be used concurrently with an oct tree block volume structure in order to dynamically sample 3D space.

The following pseudocode may be used to implement a data structure for the improved block volume sampling described herein.

Block_Volume_Structure_Improved

{
float Sample distance #configuration for the block volume
uint8*Block memory #dynamic
}

The following pseudocode may be used to implement a data structure that may be used for oct tree block volume sampling.

Block_Volume_Structure_Octree

{
uint8*Block memory #static
bool up_sampled; # if true the child_blocks are initialized
std:: array<Block_Volume_Octree*, 8>child_blocks
}

The above-described technologies may be associated with additional advantages. In one aspect, using the technologies described herein, a device (e.g., the device 104) may determine/decide whether to fit a plane to a block volume based on a number of local maxima and surface normal variance (i.e., curvature) corresponding to the local maxima. In an example, the device may fit a plane to the block volume if a surface normal histogram has one local maxima with a relatively low variance (i.e., a relatively low curvature). In another example, the device may not fit a plane to the block volume if multiple local maxima exist. In yet another example, the device may not fit a plane to a block volume if the variance (i.e., the curvature) is relatively high. In an example, an output from a surface normal histogram that has one local maxima and a relatively low variance may be used to fit a plane equation ax+by +cz+d=0 for block volume data. In another aspect, the technologies described herein may sample a block volume non-uniformly along an x-axis, a y-axis, and a z-axis (i.e., a non-equal number of voxels are sampled along the x-axis, the y-axis, and the z-axis). For instance, the technologies described herein may sample a block volume densely along a direction of a surface normal.

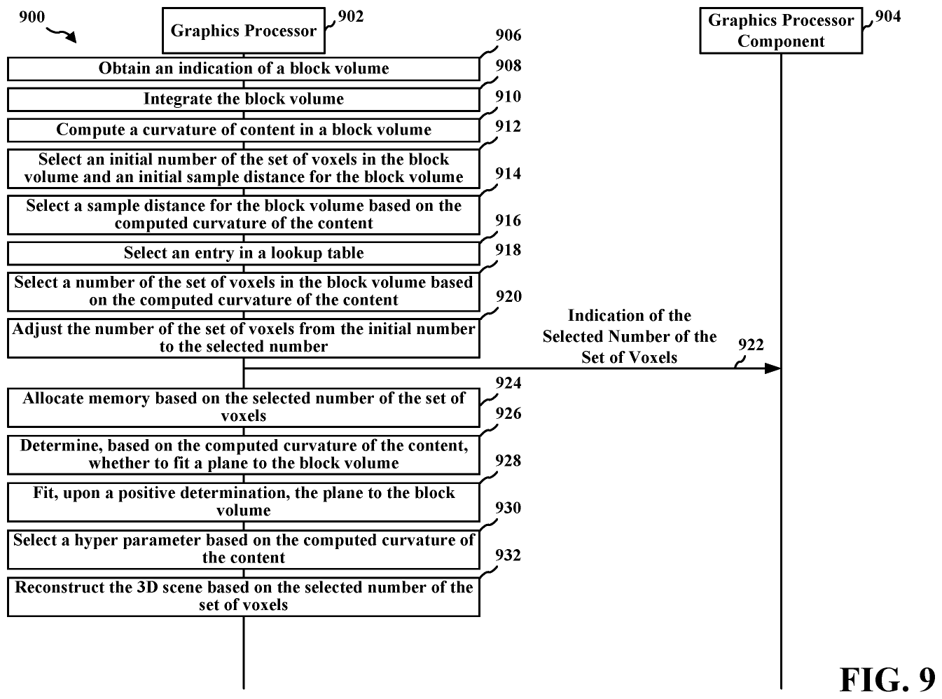

FIG. 9 is a call flow diagram 900 illustrating example communications between a graphics processor 902 and a graphics processor component 904 in accordance with one or more techniques of this disclosure. In an example, the graphics processor 902 and the graphics processor component 904 may be included in the device 104. In an example, the graphics processor 902 may be or include the GPU 200.

At 906, the graphics processor 902 may obtain an indication of a block volume. At 910, the graphics processor 902 may compute a curvature of content in a block volume that represents a three-dimensional (3D) scene, where the block volume includes a set of voxels. Computing the curvature of the content in the block volume may include computing a surface normal histogram based on the block volume and computing, based on the computed surface normal histogram, a surface variance of a local maxima of the computed surface normal histogram, where the surface variance of the local maxima may be indicative of the curvature of the content. At 918, the graphics processor 902 may select a number of the set of voxels in the block volume based on the computed curvature of the content. At 922, the graphics processor 902 may output (e.g., to the graphics processor component 904) an indication of the selected number of the set of voxels in the block volume.

At 908, the graphics processor 902 may integrate the block volume based on (1) camera pose information and (2) a TSDF value and the weight associated with each voxel in the set of voxels, where computing the curvature of the content in the block volume at 910 may include computing the curvature of the content in the block volume based on the integrated block volume. At 914, the graphics processor 902 may select a sample distance for the block volume based on the computed curvature of the content, where selecting the number of the set of voxels at 918 may include sampling the set of voxels across an x-axis, a y-axis, and a z-axis associated with the block volume based on the selected sample distance. At 912, the graphics processor 902 may select, prior to the computation of the curvature of the content at 910, an initial number of the set of voxels in the block volume and an initial sample distance for the block volume that corresponds to the initial number of the set of voxels, where the initial number of the set of voxels may differ from the selected number of the set of voxels, and where the initial sample distance may differ from the selected sample distance. At 920, the graphics processor 902 may adjust the number of the set of voxels from the initial number to the selected number. At 916, the graphics processor 902 may select, based on the surface variance of the local maxima, an entry in a lookup table, where the entry may be mapped to a type of the content in the block volume and the surface variance of the local maxima, and where selecting the number of the set of voxels at 918 may include selecting the number of the set of voxels further based on the entry.

At 932, the graphics processor 902 may reconstruct the 3D scene based on the selected number of the set of voxels. At 926, the graphics processor 902 may determine, based on the computed curvature of the content, whether to fit a plane to the block volume. At 928, the graphics processor 902 may fit, upon a positive determination, the plane to the block volume, where reconstructing the 3D scene at 932 may include reconstructing the 3D scene further based on the fitted plane. At 930, the graphics processor 902 may select a hyper parameter based on the computed curvature of the content, where reconstructing the 3D scene at 932 may include reconstructing the 3D scene further based on the selected hyper parameter. At 924, the graphics processor 902 may allocate memory based on the selected number of the set of voxels.

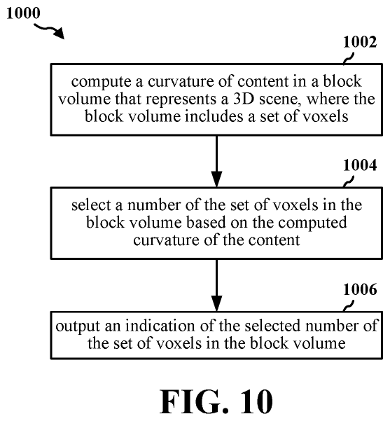

FIG. 10 is a flowchart 1000 of an example method of graphics processing in accordance with one or more techniques of this disclosure. The method may be performed by an apparatus, such as an apparatus for graphics processing, a GPU (e.g., the GPU 200, the graphics processor 902), a CPU, the device 104, a wireless communication device, and the like, as used in connection with the aspects of FIGS. 1-9. The method may be associated with various advantages, such as reducing computational complexity, bandwidth complexity, memory complexity, and/or latency of 3D reconstruction. In an example, the method may be performed by the 3D reconstructor 198.

At 1002, the apparatus (e.g., a graphics processor) computes a curvature of content in a block volume that represents a three-dimensional (3D) scene, where the block volume includes a set of voxels. For example, FIG. 9 at 912 shows that the graphics processor 902 may compute a curvature of content in a block volume that represents a three-dimensional (3D) scene, where the block volume includes a set of voxels. For example, computing the curvature of the content in the block volume may correspond to 408 in FIGS. 4, 610 and/or 612 in FIG. 6. In another example, computing the curvature of the content in the block volume may correspond to 710 and/or 712 in FIG. 7. In an example, the block volume may be or include or may be associated with the first block volume 504, the second block volume 506, the integrated block volume 606, and/or the initial block volume 804. In an example, the content may be or include the 3D surface 608. In an example, 1002 may be performed by the 3D reconstructor 198.

At 1004, the apparatus (e.g., a graphics processor) selects a number of the set of voxels in the block volume based on the computed curvature of the content. For example, FIG. 9 at 918 shows that the graphics processor 902 may select a number of the set of voxels in the block volume based on the computed curvature of the content. In an example, selecting the number of the set of voxels may correspond to 410 in FIG. 4. In an example, selecting the number of the set of voxels may include up-sampling or down-sampling as described above with respect to FIGS. 4, 7, and 8. In an example, 1004 may be performed by the 3D reconstructor 198.

At 1006, the apparatus (e.g., a graphics processor) outputs an indication of the selected number of the set of voxels in the block volume. For example, FIG. 9 at 922 shows that the graphics processor 902 may output (e.g., to the graphics processor component 904) an indication of the selected number of the set of voxels in the block volume. In an example, 1006 may be performed by the 3D reconstructor 198.

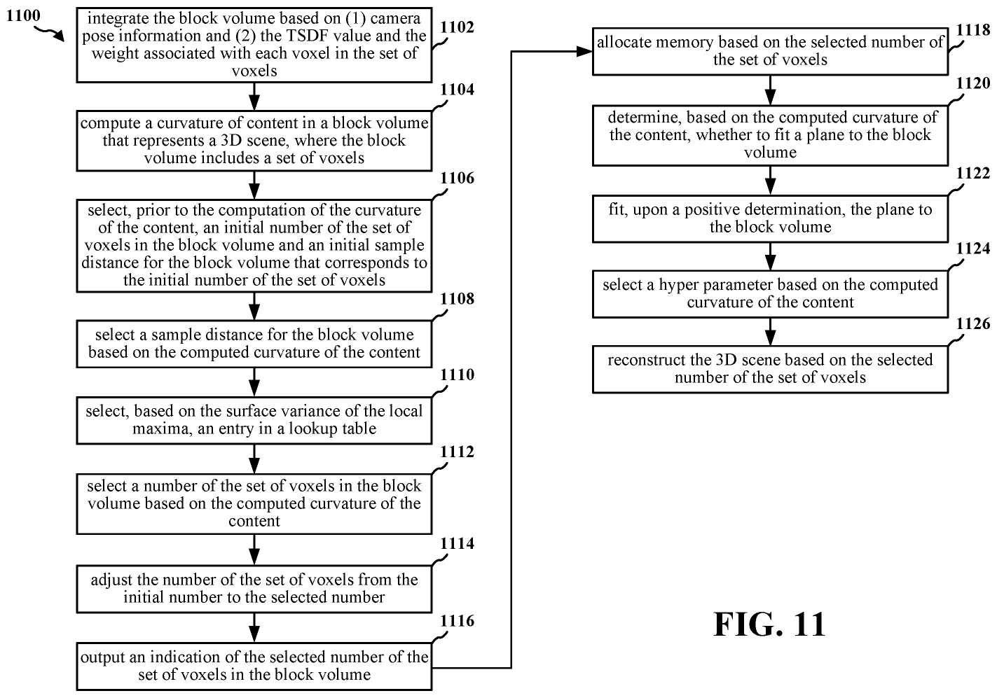

FIG. 11 is a flowchart 1100 of an example method of graphics processing in accordance with one or more techniques of this disclosure. The method may be performed by an apparatus, such as an apparatus for graphics processing, a GPU (e.g., the GPU 200, the graphics processor 902), a CPU, the device 104, a wireless communication device, and the like, as used in connection with the aspects of FIGS. 1-9. The method may be associated with various advantages, such as reducing computational complexity, bandwidth complexity, memory complexity, and/or latency of 3D reconstruction. In an example, the method (including the various aspects detailed below) may be performed by the 3D reconstructor 198.

At 1104, the apparatus (e.g., a graphics processor) computes a curvature of content in a block volume that represents a three-dimensional (3D) scene, where the block volume includes a set of voxels. For example, FIG. 9 at 912 shows that the graphics processor 902 may compute a curvature of content in a block volume that represents a three-dimensional (3D) scene, where the block volume includes a set of voxels. For example, FIG. 9 at 912 shows that the graphics processor 902 may compute a curvature of content in a block volume that represents a three-dimensional (3D) scene, where the block volume includes a set of voxels. For example, computing the curvature of the content in the block volume may correspond to 408 in FIGS. 4, 610 and/or 612 in FIG. 6. In another example, computing the curvature of the content in the block volume may correspond to 710 and/or 712 in FIG. 7. In an example, the block volume may be or include or may be associated with the first block volume 504, the second block volume 506, the integrated block volume 606, and/or the initial block volume 804. In an example, the content may be or include the 3D surface 608. In an example, 1104 may be performed by the 3D reconstructor 198.

At 1112, the apparatus (e.g., a graphics processor) selects a number of the set of voxels in the block volume based on the computed curvature of the content. For example, FIG. 9 at 918 shows that the graphics processor 902 may select a number of the set of voxels in the block volume based on the computed curvature of the content. In an example, selecting the number of the set of voxels may correspond to 410 in FIG. 4. In an example, selecting the number of the set of voxels may include up-sampling or down-sampling as described above with respect to FIGS. 4, 7, and 8. In an example, 1112 may be performed by the 3D reconstructor 198.

At 1116, the apparatus (e.g., a graphics processor) outputs an indication of the selected number of the set of voxels in the block volume. For example, FIG. 9 at 922 shows that the graphics processor 902 may output (e.g., to the graphics processor component 904) an indication of the selected number of the set of voxels in the block volume. In an example, 1116 may be performed by the 3D reconstructor 198.

In one aspect, the computed curvature of the content may be indicative of a type of the content in the block volume. For example, Table 1 above shows that the computed curvature of the content may be indicative of a type of content in the block volume. In one example, the type of the content may be an object type (e.g., a wall, a table, a water jug, a fruit, a plant, etc.). In another example, the type of the content may be a surface type (e.g., a plane, more than one plane, a cylinder, a sphere, an arbitrary complex shape, etc.).

In one aspect, each voxel in the set of voxels may be associated with a truncated signed distance function (TSDF) value and a weight. For example, each voxel in the set of voxels may be associated with address such as “000,” “001,” etc., as illustrated in FIG. 8, and each voxel may be associated with a TSDF value and a weight.

In one aspect, at 1102, the apparatus (e.g., a graphics processor) may integrate the block volume based on (1) camera pose information and (2) the TSDF value and the weight associated with each voxel in the set of voxels, where computing the curvature of the content in the block volume may include computing the curvature of the content in the block volume based on the integrated block volume. For example, FIG. 9 at 908 shows that the graphics processor 902 may integrate the block volume based on (1) camera pose information and (2) the TSDF value and the weight associated with each voxel in the set of voxels, where computing the curvature of the content in the block volume at 910 may include computing the curvature of the content in the block volume based on the integrated block volume. In an example, the aforementioned aspect may correspond to 406 in FIG. 4, the block integration unit 604 in FIGS. 6, and/or 708 in FIG. 7. In an example, 1102 may be performed by the 3D reconstructor 198.

In one aspect, at 1108, the apparatus (e.g., a graphics processor) may select a sample distance for the block volume based on the computed curvature of the content, where selecting the number of the set of voxels may include sampling the set of voxels across an x-axis, a y-axis, and a z-axis associated with the block volume based on the selected sample distance. For example, FIG. 9 at 914 shows that the graphics processor 902 may select a sample distance for the block volume based on the computed curvature of the content, where selecting the number of the set of voxels at 918 may include sampling the set of voxels across an x-axis, a y-axis, and a z-axis associated with the block volume based on the selected sample distance. For example, the aforementioned aspect may correspond to 410 in FIG. 4. In one example, the selected sample distance may be 1 cm as in 414 in FIG. 4. In another example, the selected sample distance may be 4 cm as in FIG. 4. In another example, the example 611 in FIG. 6 depicts an x-axis, a y-axis, and a z-axis. In another example, the aforementioned aspect may correspond to 714 in FIG. 7. In an example, 1108 may be performed by the 3D reconstructor 198.

In one aspect, at 1106, the apparatus (e.g., a graphics processor) may select, prior to the computation of the curvature of the content, an initial number of the set of voxels in the block volume and an initial sample distance for the block volume that corresponds to the initial number of the set of voxels, where the initial number of the set of voxels may differ from the selected number of the set of voxels, and where the initial sample distance may differ from the selected sample distance. For example, FIG. 9 at 912 shows that the graphics processor 902 may select, prior to the computation of the curvature of the content at 910, an initial number of the set of voxels in the block volume and an initial sample distance for the block volume that corresponds to the initial number of the set of voxels, where the initial number of the set of voxels may differ from the selected number of the set of voxels, and where the initial sample distance may differ from the selected sample distance. In an example, the aforementioned aspect may correspond to 404 in FIG. 4. For instance, the initial number of the set of voxels may correspond to a block size of 16 and the initial sample distance may be 2 cm. In one example, the selected number of the set of voxels may correspond to a block size of 32 and the selected sample distance may be 1 cm. In another example, the selected number of the set of voxels may correspond to a block size of 8 and the selected sample distance may be 4 cm. In an example, 1106 may be performed by the 3D reconstructor 198.

In one aspect, at 1114, the apparatus (e.g., a graphics processor) may adjust the number of the set of voxels from the initial number to the selected number. For example, FIG. 9 at 920 shows that the graphics processor 902 may adjust the number of the set of voxels from the initial number to the selected number. For example, FIG. 4 at 404 and 412 shows that adjusting the number of the set of voxels from the initial number to the selected number may correspond to changing a block size from 16 to a block size of 32. In another example, FIG. 4 at 404 and 418 shows that adjusting the number of the set of voxels from the initial number to the selected number may correspond to changing a block size from 16 to a block size of 8. In an example, 1114 may be performed by the 3D reconstructor 198.

In one aspect, adjusting the number of the set of voxels from the initial number to the selected number may include down-sampling the block volume, and where down-sampling the block volume may include decreasing the initial number to the selected number and increasing the initial sample distance to the selected sample distance. For example, the aforementioned aspect may correspond to 418, 420, and/or 422 in FIG. 4. In another example, the aforementioned aspect may correspond to 716 in FIG. 7.

In a further example, the aforementioned aspect may correspond to the down-sampled block volume 806 in FIG. 8.

In one aspect, adjusting the number of the set of voxels from the initial number to the selected number may include up-sampling the block volume, and where up-sampling the block volume may include increasing the initial number to the selected number and decreasing the initial sample distance to the selected sample distance. For example, the aforementioned aspect may correspond to 412, 414, and/or 416 in FIG. 4. In another example, the aforementioned aspect may correspond to 720 in FIG. 7. In a further example, the aforementioned aspect may correspond to the up-sampled block volume 808 in FIG. 8.

In one aspect, adjusting the number of the set of voxels from the initial number to the selected number may include adjusting the number of the set of voxels uniformly across the x-axis, the y-axis, and the z-axis by changing the initial sample distance. For example, adjusting the number of the set of voxels from the initial number to the selected number at 920 may include adjusting the number of the set of voxels uniformly across the x-axis, the y-axis, and the z-axis by changing the initial sample distance. In an example, the example 611 in FIG. 6 depicts an x-axis, a y-axis, and a z-axis.

In one aspect, adjusting the number of the set of voxels from the initial number to the selected number may include adjusting the number of the set of voxels non-uniformly across the x-axis, the y-axis, and the z-axis associated with the block volume. For example, adjusting the number of the set of voxels from the initial number to the selected number at 920 may include adjusting the number of the set of voxels non-uniformly across the x-axis, the y-axis, and the z-axis associated with the block volume. In an example, the example 611 in FIG. 6 depicts an x-axis, a y-axis, and a z-axis.

In one aspect, computing the curvature of the content in the block volume may include: computing a surface normal histogram based on the block volume. For example, computing the curvature of the content in the block volume at 910 may include: computing a surface normal histogram based on the block volume. In an example, the aforementioned aspect may correspond to 610 in FIGS. 6 and/or 710 in FIG. 7.

In one aspect, computing the curvature of the content in the block volume may further include: computing, based on the computed surface normal histogram, a surface variance of a local maxima of the computed surface normal histogram, where the surface variance of the local maxima may be indicative of the curvature of the content. For example, computing the curvature of the content in the block volume at 910 may include: computing, based on the computed surface normal histogram, a surface variance of a local maxima of the computed surface normal histogram, where the surface variance of the local maxima may be indicative of the curvature of the content. In an example, the aforementioned aspect may correspond to 612 in FIGS. 6 and/or 712 in FIG. 7.

In one aspect, at 1110, the apparatus (e.g., a graphics processor) may select, based on the surface variance of the local maxima, an entry in a lookup table, where the entry may be mapped to a type of the content in the block volume and the surface variance of the local maxima, and where selecting the number of the set of voxels may include selecting the number of the set of voxels further based on the entry. For example, FIG. 9 at 916 shows that the graphics processor 902 may select, based on the surface variance of the local maxima, an entry in a lookup table, where the entry may be mapped to a type of the content in the block volume and the surface variance of the local maxima, and where selecting the number of the set of voxels at 918 may include selecting the number of the set of voxels further based on the entry. In an example, the lookup table may be or include Table 1 above. In an example, the entry may be a row in Table 1. In an example, 1110 may be performed by the 3D reconstructor 198.

In one aspect, at 1126, the apparatus (e.g., a graphics processor) may reconstruct the 3D scene based on the selected number of the set of voxels. For example, FIG. 9 at 932 shows that the graphics processor 902 may reconstruct the 3D scene based on the selected number of the set of voxels. In an example, 1126 may be performed by the 3D reconstructor 198.

In one aspect, at 1120, the apparatus (e.g., a graphics processor) may determine, based on the computed curvature of the content, whether to fit a plane to the block volume. For example, FIG. 9 at 926 shows that the graphics processor 902 may determine, based on the computed curvature of the content, whether to fit a plane to the block volume. In an example, 1120 may be performed by the 3D reconstructor 198. In one aspect, at 1122, the apparatus (e.g., a graphics processor) may determine fit, upon a positive determination, the plane to the block volume, where reconstructing the 3D scene may include reconstructing the 3D scene further based on the fitted plane. For example, FIG. 9 at 928 shows that the graphics processor 902 may determine fit, upon a positive determination, the plane to the block volume, where reconstructing the 3D scene at 932 may include reconstructing the 3D scene further based on the fitted plane. In an example, 1122 may be performed by the 3D reconstructor 198.

In one aspect, at 1124, the apparatus (e.g., a graphics processor) may select a hyper parameter based on the computed curvature of the content, where reconstructing the 3D scene may include reconstructing the 3D scene further based on the selected hyper parameter. For example, FIG. 9 at 930 shows that the graphics processor 902 may select a hyper parameter based on the computed curvature of the content, where reconstructing the 3D scene at 932 may include reconstructing the 3D scene further based on the selected hyper parameter. In an example, the hyper parameter may be a ramp size. In an example, 1124 may be performed by the 3D reconstructor 198.

In one aspect, the curvature of the content may be indicative of: a single plane, a plurality of planes, a cylinder, a sphere, or a complex shape. For example, Table 1 shows that the curvature of the content may be indicative of: a single plane, a plurality of planes, a cylinder, a sphere, or a complex shape.

In one aspect, at 1118, the apparatus (e.g., a graphics processor) may allocate memory based on the selected number of the set of voxels. For example, FIG. 9 at 924 shows that the graphics processor 902 may allocate memory based on the selected number of the set of voxels. In an example, the aforementioned aspect may correspond to 718 or 722 in FIG. 7. In an example, 1118 may be performed by the 3D reconstructor 198.

In one aspect, outputting the indication of the selected number of the set of voxels in the block volume at 922 may include: storing the indication of the selected number of the set of voxels in memory; or transmitting the indication of the selected number of the set of voxels in the block volume. For example, outputting the indication of the selected number of the set of voxels in the block volume may include: storing the indication of the selected number of the set of voxels in memory; or transmitting (e.g., to the graphics processor component 904) the indication of the selected number of the set of voxels in the block volume.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for computing a curvature of content in a block volume that represents a three-dimensional (3D) scene, where the block volume includes a set of voxels. The apparatus may further include means for selecting a number of the set of voxels in the block volume based on the computed curvature of the content. The apparatus may further include means for outputting an indication of the selected number of the set of voxels in the block volume. The apparatus may further include means for integrating the block volume based on (1) camera pose information and (2) the TSDF value and the weight associated with each voxel in the set of voxels, where computing the curvature of the content in the block volume includes computing the curvature of the content in the block volume based on the integrated block volume. The apparatus may further include means for selecting a sample distance for the block volume based on the computed curvature of the content, where selecting the number of the set of voxels includes sampling the set of voxels across an x-axis, a y-axis, and a z-axis associated with the block volume based on the selected sample distance. The apparatus may further include means for selecting, prior to the computation of the curvature of the content, an initial number of the set of voxels in the block volume and an initial sample distance for the block volume that corresponds to the initial number of the set of voxels, where the initial number of the set of voxels differs from the selected number of the set of voxels, and where the initial sample distance differs from the selected sample distance. The apparatus may further include means for adjusting the number of the set of voxels from the initial number to the selected number. The apparatus may further include means for selecting, based on the surface variance of the local maxima, an entry in a lookup table, where the entry is mapped to a type of the content in the block volume and the surface variance of the local maxima, and where selecting the number of the set of voxels includes selecting the number of the set of voxels further based on the entry. The apparatus may further include means for reconstructing the 3D scene based on the selected number of the set of voxels. The apparatus may further include means for determining, based on the computed curvature of the content, whether to fit a plane to the block volume. The apparatus may further include means for fitting, upon a positive determination, the plane to the block volume, where reconstructing the 3D scene includes reconstructing the 3D scene further based on the fitted plane. The apparatus may further include means for selecting a hyper parameter based on the computed curvature of the content, where reconstructing the 3D scene includes reconstructing the 3D scene further based on the selected hyper parameter. The apparatus may further include means for allocating memory based on the selected number of the set of voxels.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A. B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, including: computing a curvature of content in a block volume that represents a three-dimensional (3D) scene, wherein the block volume includes a set of voxels; selecting a number of the set of voxels in the block volume based on the computed curvature of the content; and outputting an indication of the selected number of the set of voxels in the block volume.
Aspect 2 may be combined with aspect 1, wherein the computed curvature of the content is indicative of a type of the content in the block volume.
Aspect 3 may be combined with any of aspects 1-2, wherein each voxel in the set of voxels is associated with a truncated signed distance function (TSDF) value and a weight.
Aspect 4 may be combined with aspect 3, further including: integrating the block volume based on (1) camera pose information and (2) the TSDF value and the weight associated with each voxel in the set of voxels, wherein computing the curvature of the content in the block volume includes computing the curvature of the content in the block volume based on the integrated block volume.
Aspect 5 may be combined with any of aspects 1-4, further including: selecting a sample distance for the block volume based on the computed curvature of the content, wherein selecting the number of the set of voxels includes sampling the set of voxels across an x-axis, a y-axis, and a z-axis associated with the block volume based on the selected sample distance.
Aspect 6 may be combined with aspect 5, further including: selecting, prior to the computation of the curvature of the content, an initial number of the set of voxels in the block volume and an initial sample distance for the block volume that corresponds to the initial number of the set of voxels, wherein the initial number of the set of voxels differs from the selected number of the set of voxels, and wherein the initial sample distance differs from the selected sample distance.
Aspect 7 may be combined with aspect 6, further including: adjusting the number of the set of voxels from the initial number to the selected number.
Aspect 8 may be combined with aspect 7, wherein adjusting the number of the set of voxels from the initial number to the selected number includes down-sampling the block volume, and wherein down-sampling the block volume includes decreasing the initial number to the selected number and increasing the initial sample distance to the selected sample distance.
Aspect 9 may be combined with aspect 7, wherein adjusting the number of the set of voxels from the initial number to the selected number includes up-sampling the block volume, and wherein up-sampling the block volume includes increasing the initial number to the selected number and decreasing the initial sample distance to the selected sample distance.
Aspect 10 may be combined with any of aspects 6-9, wherein adjusting the number of the set of voxels from the initial number to the selected number includes adjusting the number of the set of voxels uniformly across the x-axis, the y-axis, and the z-axis by changing the initial sample distance.
Aspect 11 may be combined with any of aspects 6-9, wherein adjusting the number of the set of voxels from the initial number to the selected number includes adjusting the number of the set of voxels non-uniformly across the x-axis, the y-axis, and the z-axis associated with the block volume.
Aspect 12 may be combined with any of aspects 1-11, wherein computing the curvature of the content in the block volume includes: computing a surface normal histogram based on the block volume; and computing, based on the computed surface normal histogram, a surface variance of a local maxima of the computed surface normal histogram, wherein the surface variance of the local maxima is indicative of the curvature of the content.
Aspect 13 may be combined with aspect 12, further including: selecting, based on the surface variance of the local maxima, an entry in a lookup table, wherein the entry is mapped to a type of the content in the block volume and the surface variance of the local maxima, and wherein selecting the number of the set of voxels includes selecting the number of the set of voxels further based on the entry.
Aspect 14 may be combined with any of aspects 12-13, further including: reconstructing the 3D scene based on the selected number of the set of voxels.
Aspect 15 may be combined with aspect 14, further including: determining, based on the computed curvature of the content, whether to fit a plane to the block volume; and fitting, upon a positive determination, the plane to the block volume, wherein reconstructing the 3D scene includes reconstructing the 3D scene further based on the fitted plane.
Aspect 16 may be combined with any of aspects 14-15, further including: selecting a hyper parameter based on the computed curvature of the content, wherein reconstructing the 3D scene includes reconstructing the 3D scene further based on the selected hyper parameter.
Aspect 17 may be combined with any of aspects 1-16, wherein the curvature of the content is indicative of: a single plane, a plurality of planes, a cylinder, a sphere, or a complex shape.
Aspect 18 may be combined with any of aspects 1-17, further including: allocating memory based on the selected number of the set of voxels.
Aspect 19 may be combined with any of aspects 1-18, wherein outputting the indication of the selected number of the set of voxels in the block volume includes: storing the indication of the selected number of the set of voxels in memory; or transmitting the indication of the selected number of the set of voxels in the block volume.
Aspect 20 is an apparatus for graphics processing including a processor coupled to a memory and, based on information stored in the memory, the processor is configured to implement a method as in any of aspects 1-19.
Aspect 21 may be combined with aspect 20 and includes that the apparatus is a wireless communication device comprising at least one of a transceiver or an antenna coupled to the processor, wherein the processor is further configured to obtain an indication of the block volume via at least one of the transceiver or the antenna wherein the computation of the curvature of content is based on the indication of the block volume.
Aspect 22 is an apparatus for graphics processing including means for implementing a method as in any of aspects 1-19.
Aspect 23 is a computer-readable medium (e.g., a non-transitory computer-readable medium) storing computer executable code, the computer executable code, when executed by a processor, causes the processor to implement a method as in any of aspects 1-19.

Various aspects have been described herein. These and other aspects are within the scope of the following claims.

What is claimed is:

1. An apparatus for graphics processing, comprising:
a memory; and
a processor coupled to the memory and, based on information stored in the memory, the processor is configured to:
compute a curvature of content in a block volume that represents a three-dimensional (3D) scene, wherein the block volume includes a set of voxels;
select a number of the set of voxels in the block volume based on the computed curvature of the content; and
output an indication of the selected number of the set of voxels in the block volume.

2. The apparatus of claim 1, wherein the computed curvature of the content is indicative of a type of the content in the block volume.

3. The apparatus of claim 1, wherein each voxel in the set of voxels is associated with a truncated signed distance function (TSDF) value and a weight.

4. The apparatus of claim 3, wherein the processor is further configured to:
integrate the block volume based on (1) camera pose information and (2) the TSDF value and the weight associated with each voxel in the set of voxels, wherein to compute the curvature of the content in the block volume, the processor is configured to compute the curvature of the content in the block volume based on the integrated block volume.

5. The apparatus of claim 1, wherein the processor is further configured to:
select a sample distance for the block volume based on the computed curvature of the content, wherein to select the number of the set of voxels, the processor is configured to sample the set of voxels across an x-axis, a y-axis, and a z-axis associated with the block volume based on the selected sample distance.

6. The apparatus of claim 5, wherein the processor is further configured to:
select, prior to the computation of the curvature of the content, an initial number of the set of voxels in the block volume and an initial sample distance for the block volume that corresponds to the initial number of the set of voxels, wherein the initial number of the set of voxels differs from the selected number of the set of voxels, and wherein the initial sample distance differs from the selected sample distance.

7. The apparatus of claim 6, wherein the processor is further configured to:
adjust the number of the set of voxels from the initial number to the selected number.

8. The apparatus of claim 7, wherein to adjust the number of the set of voxels from the initial number to the selected number, the processor is configured to down-sample the block volume, and wherein to down-sample the block volume, the processor is configured to decrease the initial number to the selected number and increase the initial sample distance to the selected sample distance.

9. The apparatus of claim 7, wherein to adjust the number of the set of voxels from the initial number to the selected number, the processor is configured to up-sample the block volume, and wherein to up-sample the block volume, the processor is configured to increase the initial number to the selected number and decrease the initial sample distance to the selected sample distance.

10. The apparatus of claim 6, wherein to adjust the number of the set of voxels from the initial number to the selected number, the processor is configured to adjust the number of the set of voxels uniformly across the x-axis, the y-axis, and the z-axis via a change in the initial sample distance.

11. The apparatus of claim 6, wherein to adjust the number of the set of voxels from the initial number to the selected number, the processor is configured to adjust the number of the set of voxels non-uniformly across the x-axis, the y-axis, and the z-axis via a change in the initial sample distance.

12. The apparatus of claim 1, wherein to compute the curvature of the content in the block volume, the processor is configured to:
compute a surface normal histogram based on the block volume; and
compute, based on the computed surface normal histogram, a surface variance of a local maxima of the computed surface normal histogram, wherein the surface variance of the local maxima is indicative of the curvature of the content.

13. The apparatus of claim 12, wherein the processor is further configured to:
select, based on the surface variance of the local maxima, an entry in a lookup table, wherein the entry is mapped to a type of the content in the block volume and the surface variance of the local maxima, and wherein to select the number of the set of voxels, the processor is configured to select the number of the set of voxels further based on the entry.

14. The apparatus of claim 12, wherein the processor is further configured to:
reconstruct the 3D scene based on the selected number of the set of voxels.

15. The apparatus of claim 14, wherein the processor is further configured to:
determine, based on the computed curvature of the content, whether to fit a plane to the block volume; and
fit, upon a positive determination, the plane to the block volume, wherein to reconstruct the 3D scene, the processor is configured to reconstruct the 3D scene further based on the fitted plane.

16. The apparatus of claim 14, wherein the processor is further configured to:
select a hyper parameter based on the computed curvature of the content, wherein to reconstruct the 3D scene, the processor is configured to reconstruct the 3D scene further based on the selected hyper parameter.

17. The apparatus of claim 1, wherein the curvature of the content is indicative of:
a single plane,
a plurality of planes,
a cylinder,
a sphere, or
a complex shape.

18. The apparatus of claim 1, wherein the processor is further configured to:
allocate the memory based on the selected number of the set of voxels.

19. The apparatus of claim 1, wherein to output the indication of the selected number of the set of voxels in the block volume, the processor is configured to:
store the indication of the selected number of the set of voxels in the memory; or
transmit the indication of the selected number of the set of voxels in the block volume.

20. The apparatus of claim 1, wherein the apparatus is a wireless communication device comprising at least one of a transceiver or an antenna coupled to the processor, and wherein the processor is further configured to obtain an indication of the block volume via at least one of the transceiver or the antenna, wherein the computation of the curvature of content is based on the indication of the block volume.

21. A method of graphics processing, comprising:
computing a curvature of content in a block volume that represents a three-dimensional (3D) scene, wherein the block volume includes a set of voxels;
selecting a number of the set of voxels in the block volume based on the computed curvature of the content; and
outputting an indication of the selected number of the set of voxels in the block volume.

22. The method of claim 21, wherein the computed curvature of the content is indicative of a type of the content in the block volume.

23. The method of claim 21, wherein each voxel in the set of voxels is associated with a truncated signed distance function (TSDF) value and a weight.

24. The method of claim 23, further comprising:
integrating the block volume based on (1) camera pose information and (2) the TSDF value and the weight associated with each voxel in the set of voxels, wherein computing the curvature of the content in the block volume comprises computing the curvature of the content in the block volume based on the integrated block volume.

25. The method of claim 21, further comprising:
selecting a sample distance for the block volume based on the computed curvature of the content, wherein selecting the number of the set of voxels comprises sampling the set of voxels across an x-axis, a y-axis, and a z-axis associated with the block volume based on the selected sample distance.

26. The method of claim 25, further comprising:
selecting, prior to the computation of the curvature of the content, an initial number of the set of voxels in the block volume and an initial sample distance for the block volume that corresponds to the initial number of the set of voxels, wherein the initial number of the set of voxels differs from the selected number of the set of voxels, and wherein the initial sample distance differs from the selected sample distance.

27. The method of claim 26, further comprising:
adjusting the number of the set of voxels from the initial number to the selected number.

28. The method of claim 27, wherein adjusting the number of the set of voxels from the initial number to the selected number comprises down-sampling the block volume, and wherein down-sampling the block volume comprises decreasing the initial number to the selected number and increasing the initial sample distance to the selected sample distance.

29. The method of claim 27, wherein adjusting the number of the set of voxels from the initial number to the selected number comprises up-sampling the block volume, and wherein up-sampling the block volume comprises increasing the initial number to the selected number and decreasing the initial sample distance to the selected sample distance.

30. A computer-readable medium storing computer executable code, the computer executable code, when executed by a processor, causes the processor to:
compute a curvature of content in a block volume that represents a three-dimensional (3D) scene, wherein the block volume includes a set of voxels;
select a number of the set of voxels in the block volume based on the computed curvature of the content; and
output an indication of the selected number of the set of voxels in the block volume.
